(19) United States
(12) Patent Application Publication
(10) Pub. No.: US 2026/0129286 A1
(43) Pub. Date: May 7, 2026

(54) IMAGE CAPTURING APPARATUS CONFIGURABLE FOR AUTONOMOUS OPERATION, CONTROL METHOD FOR THE SAME, AND STORAGE MEDIUM

(71) Applicant: CANON KABUSHIKI KAISHA, Tokyo (JP)

(72) Inventors: YASUHIRO MIZOBUCHI, Tokyo (JP); MASAHIRO SHINDO, Kanagawa (JP)

(21) Appl. No.: 19/368,817

(22) Filed: Oct. 24, 2025

(30) Foreign Application Priority Data
Nov. 1, 2024 (JP) 2024-193301

(51) Int. Cl. H04N 23/60; H04N 23/617; H04N 23/69; H04N 23/695

(52) U.S. Cl. CPC H04N 23/64; H04N 23/617; H04N 23/69; H04N 23/695

(57) ABSTRACT

An imaging apparatus including one or more processors that execute a program stored in a memory and thereby function as an input unit configured to receive an input of arbitrary sentence information as an imaging instruction, a transmission unit configured to transmit the arbitrary sentence information received by the input unit to a generation unit for generating an imaging condition based on an arbitrary sentence, a reception unit configured to receive the imaging condition from the generation unit, an output unit configured to output an imaging plan based on the imaging condition received by the reception unit, and a control unit configured to control an imaging unit to perform imaging based on the imaging plan.

### BACKGROUND

### Field of the Technology

The present disclosure relates to an imaging apparatus that automatically captures an image based on an imaging instruction from a user, a method for controlling the same, and a storage medium.

### Description of the Related Art

In recent years, systems that automatically start an imaging process in response to a user voice input have reached a practical application stage. This technique significantly reduces the need for manual operation and enables more intuitive and faster imaging. Japanese Patent Application Laid-Open No. 2022-111133 describes an imaging instruction method in which, if a user speaks a password to start imaging (for example, “Take a picture” or the like), the user's voice is recognized by a voice processing unit and used as a trigger to perform an imaging operation.

According to the technique described in Japanese Patent Application Laid-Open No. 2022-111133, voice commands are limited to phrases registered in advance, and a user needs to memorize and use the specific registered phrases.

### SUMMARY

The present disclosure has been made in consideration of the above situation and is directed to providing of an imaging apparatus that can control an imaging operation in response to an automatic imaging instruction of arbitrary expression received from a user.

According to an aspect of the present disclosure, an imaging apparatus includes one or more processors that execute a program stored in a memory and thereby function as an input unit configured to receive an input of arbitrary sentence information as an imaging instruction, a transmission unit configured to transmit the arbitrary sentence information received by the input unit to a generation unit for generating an imaging condition based on an arbitrary sentence, a reception unit configured to receive the imaging condition from the generation unit, an output unit configured to output an imaging plan based on the imaging condition received by the reception unit, and a control unit configured to control an imaging unit to perform imaging based on the imaging plan.

Features of the present disclosure will become apparent from the following description of embodiments with reference to the attached drawings. The following description of embodiments is described by way of example.

### BRIEF DESCRIPTION OF THE DRAWINGS

FIG. 1 is schematic diagram illustrating an imaging apparatus according to first, second, and third embodiments.

FIG. 2 is a block diagram illustrating a configuration of the imaging apparatus according to the first, second, and third embodiments.

FIG. 3 is a diagram illustrating a configuration of an imaging purpose estimation server according to the first and second embodiments.

FIG. 4 is a diagram illustrating a configuration of the imaging apparatus and the imaging purpose estimation server according to the first and second embodiments.

FIG. 5 is a diagram illustrating a prompt according to the first embodiment.

FIG. 6 is a flowchart illustrating a procedure from receiving a user instruction to performing an imaging operation according to the first embodiment.

FIG. 7 is a diagram illustrating imaging purposes and imaging plans that are output in response to a user instruction according to the first embodiment.

FIG. 8 is a flowchart illustrating an imaging plan generation operation according to the first and second embodiments.

FIG. 9 is a diagram illustrating a rising-sun flag composition adjustment operation according to the first and second embodiments.

FIGS. 10A and 10B are diagrams each illustrating a rule-of-thirds composition adjustment operation according to the first and second embodiments.

FIG. 11 is a flowchart illustrating a procedure from receiving a user instruction to inquiring about a missing imaging condition and performing an imaging operation according to the second embodiment.

FIG. 12 is a diagram illustrating a prompt according to the second embodiment.

FIG. 13 is a diagram illustrating a configuration of an imaging purpose estimation server according to the third embodiment.

FIG. 14 is a diagram illustrating a configuration of the imaging apparatus and the imaging purpose estimation server according to the third embodiment.

FIG. 15 is a diagram illustrating a prompt according to the third embodiment.

FIG. 16 is a flowchart illustrating a procedure from receiving a user instruction to performing an imaging operation according to the third embodiment.

FIG. 17 is a diagram illustrating keyword outputs according to the third embodiment.

FIG. 18 is a diagram illustrating response history records according to the third embodiment.

FIG. 19 is a diagram illustrating response history searches according to the third embodiment.

### DESCRIPTION OF THE EMBODIMENTS

The present disclosure will now be described in detail based on embodiments with reference to the accompanying drawings.

The following embodiments do not limit the disclosure as defined in the claims. Although multiple features are described in the embodiments, not all of them are necessarily essential to the disclosure, and the features may be combined arbitrarily. Furthermore, in the accompanying drawings, identical or similar components are denoted by the same reference numerals, and redundant descriptions are omitted.

In the following embodiments, the present disclosure will be described in the case of implementation using an imaging apparatus with pan/tilt functions. However, an imaging apparatus may be a digital camera, a video camera, a smartphone, a tablet, a wearable camera, a smartwatch, smart glasses, a web camera, a security camera, a game machine, a robot, a drone, or a drive recorder. These are examples, and the present disclosure can also be implemented using an imaging apparatus having other imaging functions.

### First Embodiment

According to the present embodiment, an example of processing for executing desired imaging is described even in a case where an imaging instruction from a user to an imaging apparatus includes colloquial expressions, such as “Take a picture with Mr. A at the center,” “Keep taking pictures of the children,” and “Take a lot of pictures for about five minutes.”

### (Schematic Diagram of Imaging Apparatus)

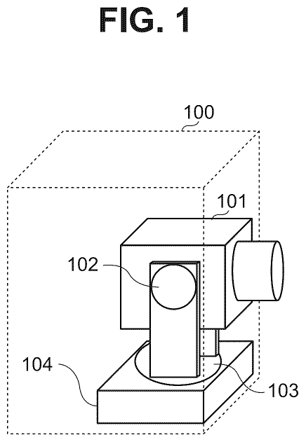

FIG. 1 is a schematic diagram illustrating an imaging apparatus 100 according to a first embodiment.

The imaging apparatus 100 includes a lens barrel 101, a tilt rotation unit 102 that drives the lens barrel 101 in a tilt direction, a pan rotation unit 103 that drives the lens barrel 101 in a pan direction, and a control box 104 that controls imaging and autonomous movement.

The lens barrel 101 includes an imaging optical system for imaging and an imaging element for acquiring image data based on light from the imaging optical system, and is mounted to the imaging apparatus 100 via a rotation mechanism that can rotate and drive with respect to a fixed portion (not illustrated) of the imaging apparatus 100.

The tilt rotation unit 102 and the pan rotation unit 103 change imaging directions of the lens barrel 101. The tilt rotation unit 102 includes a motor serving as an actuator and a rotation mechanism (motor drive mechanism) that is driven to rotate by the motor so that the lens barrel 101 can rotate in the tilt direction. The pan rotation unit 103 includes a motor serving as an actuator and a rotation mechanism (motor drive mechanism) that is driven to rotate by the motor so that the lens barrel 101 can rotate in the pan direction.

The control box 104 is provided with a control microcomputer that controls an imaging lens group included in the lens barrel 101, the tilt rotation unit 102, and the pan rotation unit 103, and the like. In the present embodiment, the control box 104 is disposed within the fixed portion of the imaging apparatus 100 and remains fixed even in a case where the lens barrel 101 performs pan and tilt drive.

### (Configuration of Imaging Apparatus)

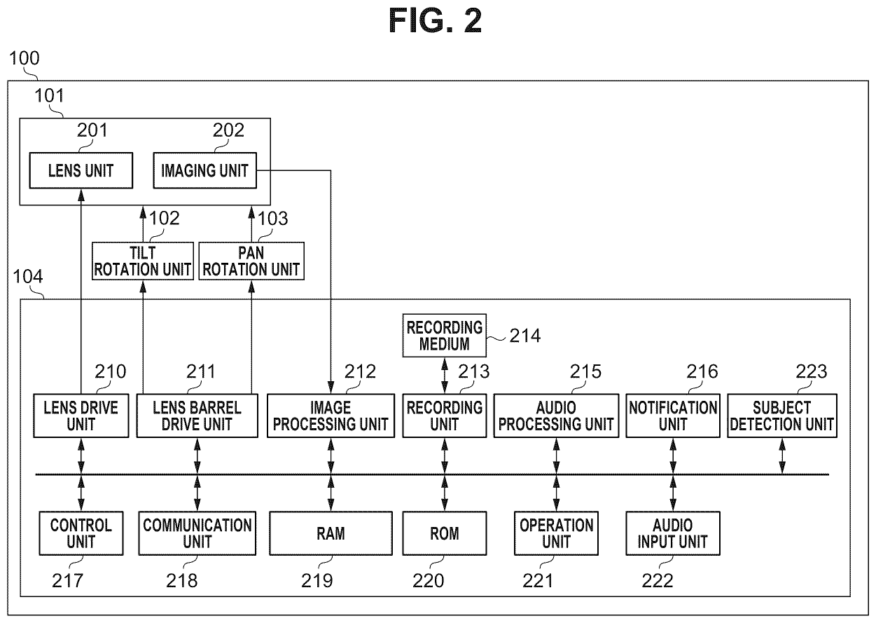

FIG. 2 is a block diagram illustrating a configuration of the imaging apparatus 100 according to the present embodiment.

A lens unit 201 includes a zoom unit and a focus unit. The zoom unit includes a zoom lens that performs variable magnification. The focus unit includes a focus lens that adjusts focus. The lens unit 201 is driven and controlled by a lens drive unit 210.

An imaging unit 202 includes an imaging element for receiving light incident through each lens group and generates charge information corresponding to an amount of the light as analog image data. The analog image data is output to an image processing unit 212.

A lens barrel drive unit 211 drives the tilt rotation unit 102 and the pan rotation unit 103. Thus, the lens barrel 101 can be driven to rotate in the tilt direction and the pan direction. The lens barrel drive unit 211 is controlled to drive by a control unit 217.

The imaging apparatus 100 uses an aperture control unit, a sensor gain control unit, and a shutter control unit, which are not illustrated, to control exposure so that a subject has appropriate brightness.

The image processing unit 212 converts the analog image data input from the imaging unit 202 into digital image data by analog-to-digital (A/D) conversion. The image processing unit 212 applies image processing, such as distortion correction, white balance adjustment, color interpolation processing, and the like, to the digital image data and outputs the digital image data after applying the processing. The digital image data output from the image processing unit 212 is converted into a recording format, such as a Joint Photographic Experts Group (JPEG) format or the like, by a recording unit 213 and transmitted to a random-access memory (RAM) 219 or a recording medium 214.

The recording unit 213 records a compressed image signal and a compressed audio signal generated by the image processing unit 212 and an audio processing unit 215, other control data related to imaging, and the like to the recording medium 214. In a case where an audio signal is not compressed and encoded, the control unit 217 transmits the audio signal generated by the audio processing unit 215 and the compressed image signal generated by the image processing unit 212 to the recording unit 213 to record them in the recording medium 214.

While the recording medium 214 is built in the imaging apparatus 100, the recording medium 214 may also be a removable recording medium. The recording medium 214 can record various types of data, such as a compressed image signal, a compressed audio signal, an audio signal, and the like, which are generated by the imaging apparatus 100. Thus, a medium having a larger capacity than a read-only memory (ROM) 220 is generally used as the recording medium 214. For example, the recording medium 214 may be any type of recording medium, such as a hard disk, an optical disk, a magneto-optical disk, a compact disc-recordable (CD-R), a digital versatile disc-recordable (DVD-R), a magnetic tape, a nonvolatile semiconductor memory, a flash memory, or the like.

The audio processing unit 215 performs audio-related processing, such as processing for optimizing an input digital audio signal and the like. Then, the audio signal processed by the audio processing unit 215 is transmitted to the RAM 219 by the control unit 217. The RAM 219 temporarily stores the image signal and the audio signal acquired from the image processing unit 212 and the audio processing unit 215.

A notification unit 216 has, for example, a display function of outputting visually recognizable information, such as a liquid crystal display (LCD) or a light-emitting diode (LED), or a function of outputting sound, such as a speaker, and notifies a user of various types of information.

An operation unit 221 is an input device that receives various operations performed by a user. As the operation unit 221, for example, a touch panel or a physical button can be used. The touch panel is provided, for example, on a display surface of the notification unit 216 and integrated with the notification unit 216.

The operation unit 221 and the notification unit 216 may be detachable or undetachable from the imaging apparatus 100. The operation unit 221 and the notification unit 216 may be implemented as a single application on a general-purpose computing device, such as a smartphone.

The image processing unit 212 and the audio processing unit 215 read out the image signal and the audio signal temporarily stored in the RAM 219 and encode the image signal and the audio signal separately to generate a compressed image signal and a compressed audio signal.

The control unit 217 is configured with, for example, a central processing unit (CPU) (micro processing unit (MPU)), a memory (dynamic RAM (DRAM) or static RAM (SRAM)), a nonvolatile memory (electrically erasable and programmable ROM (EEPROM)), or the like. The control unit 217 executes various types of processing (stored program) to control each block in the imaging apparatus 100 and control data transfer between respective blocks.

The ROM 220 is an electrically erasable and programmable memory and stores a constant, a program, and the like for use in an operation of the control unit 217.

An audio input unit 222 acquires an audio signal in the vicinity of the imaging apparatus 100 via a microphone provided in the imaging apparatus 100, performs analog-to-digital conversion of the audio signal, and transmits the audio signal to the audio processing unit 215.

A communication unit 218 performs communication between the imaging apparatus 100 and an external apparatus and transmits and receives data, such as an audio signal, an image signal, a compressed audio signal, a compressed image signal, and the like. In a case where the imaging apparatus 100 detects an abnormal state, the communication unit 218 transmits information for notifying the external apparatus of an internal state of the imaging apparatus, such as error information and the like. The communication unit 218 may include a wireless communication module, such as an infrared communication module, a Bluetooth® communication module, a wireless local area network (LAN) communication module, a wireless Universal Serial Bus (USB), a Global Positioning System (GPS) receiver, or the like.

A subject detection unit 223 detects a subject included in a captured image and determines an attribute of the subject. For example, the subject detection unit 223 detects the face and body of the subject. In face detection processing, a pattern for determining the face of the subject is set in advance, and a portion included in the captured image that matches the pattern can be detected as a face image of the subject.

Reliability indicating likelihood of the face of the subject is also output at the same time, and the reliability is output based on, for example, a size of a face area in the image, a coincidence degree with a face pattern, and the like. Similarly, in object recognition, recognition of an object that matches a pattern registered in advance can also be performed.

The subject detection unit 223 identifies an individual whose face has been registered in advance (personal authentication). The imaging apparatus 100 according to the present embodiment has a face registration mode. In the face registration mode, feature information indicating a feature amount of a detected face area is registered in dictionary data. When performing personal authentication, organs, such as eyes and a mouth, of a person present in a captured image are detected to extract a feature amount of the person's face, and similarity with the feature amount of the face (registered subject) registered in advance in the dictionary data is calculated. Then, in a case where the similarity is equal to or more than a threshold value, the face of the person in the captured image is determined to be the face of the person already registered in the dictionary data, whereby the individual is authenticated.

There is also a method for extracting a featured subject using a histogram of hue, color saturation, or the like in a captured image. In this case, processing is performed to divide a distribution derived from the histogram of the hue, color saturation, or the like of the image of the subject captured within the imaging field into a plurality of sections, and classify the captured image for each section. For example, histograms of a plurality of color components are generated for the captured image, and the captured image is divided into sections based on its range of peak values. Then, the captured image is grouped into regions corresponding to the same section combinations, and the image area of the subject is recognized. An evaluation value is output for each image area of the recognized subject, so that the image area of the subject with the highest evaluation value can be determined as a main subject area. By using this method, subject information for each subject can be acquired from imaging information using the above-described method.

The subject detection unit 223 further performs attribute estimation on the detected subject. The attribute estimation is performed on the detected face area using a determination formula, which is defined in advance from edge information on the eyes, mouth, and others, a contour, and the like. The method and the details, such as using machine learning, are not specified in other embodiments. Here, according to the present embodiment, a type of the subject, namely, a biological classification, such as a human, a cat, or other, is estimated. The attribute to be estimated may be any attribute other than that, and, for example, race, facial orientation, facial shape, organ, hair color, and presence or absence of an accessory (mask, glasses, sunglasses, eye patch, bandage, collar, etc.) may be included.

The control unit 217 further has a function of registering subject information. In the above-described face registration mode, the control unit 217 registers a combination of a face picture, feature information indicating the feature amount of the face area, name, and birth date of a subject in the imaging apparatus 100. A user can use the operation unit 221 to input desired information. The subject information is recorded in the recording medium 214 by the recording unit 213.

The audio input unit 222 and the audio processing unit 215 further function to input arbitrary sentence instruction.

The audio processing unit 215 detects a break in the input audio data and converts the audio data into a character string. The converted character string data is transmitted to the control unit 217. One method for breaking the audio data is, for example, to break the audio data at a point where a certain period of silence has continued in the input audio. Alternatively, various methods may be used, such as a method in which a user explicitly specifies a break by using a pressing state of an audio input button (not illustrated) or a method in which a specific word or sound is used as a mark for a break. One method for converting audio data into a character string is to use deep learning. For example, Whisper and its derivative Whisper.cpp by OpenAI Inc. have been proposed. Processing for converting audio data into a character string may be performed by a device other than the imaging apparatus 100 and may be performed by a server or a web service (not illustrated) via the communication unit 218. An example of a web service that converts audio data into a character string is Speech-to-Text provided by Google.

### (Description of Imaging Purpose Estimation Server)

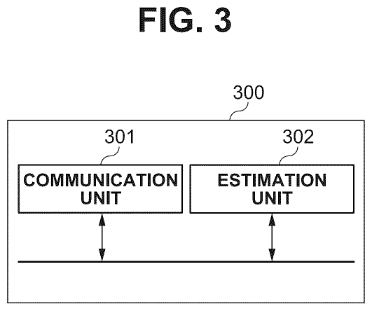

FIG. 3 is a diagram illustrating a configuration of an imaging purpose estimation server 300 that has a function of generating an imaging condition. An imaging purpose estimation server 300 includes a communication unit 301 and an estimation unit 302.

The communication unit 301 communicates with the imaging apparatus 100. The communication unit 301 receives a prompt 500 transmitted from the imaging apparatus 100 and transmits imaging conditions estimated by the estimation unit 302 (for example, settings of an imaging target subject, a composition, an imaging period, an imaging frequency, and the like) to the imaging apparatus 100. The prompt is input data to the estimation unit 302. The prompt 500 is described in detail below. The communication unit 301 may include a wireless communication module, such as an infrared communication module, a Bluetooth® communication module, a wireless LAN communication module, a wireless USB, a GPS receiver, or the like.

The estimation unit 302 is configured by large language models (LLM). The large language model is a deep learning model configured with an artificial neural network having a large number of parameters and generates and outputs an appropriate response to an instruction (prompt) in natural language. According to the present embodiment, the estimation unit 302 estimates the imaging conditions based on the input prompt 500. For example, a large language model provided by OpenAI Inc. may be used as the imaging purpose estimation server 300.

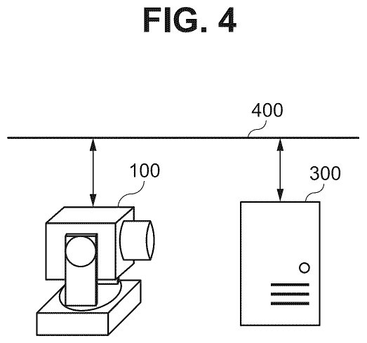

The imaging apparatus 100 and the imaging purpose estimation server 300 exchange information via a network 400 using their respective communication units (FIG. 4).

### (Description of Prompt)

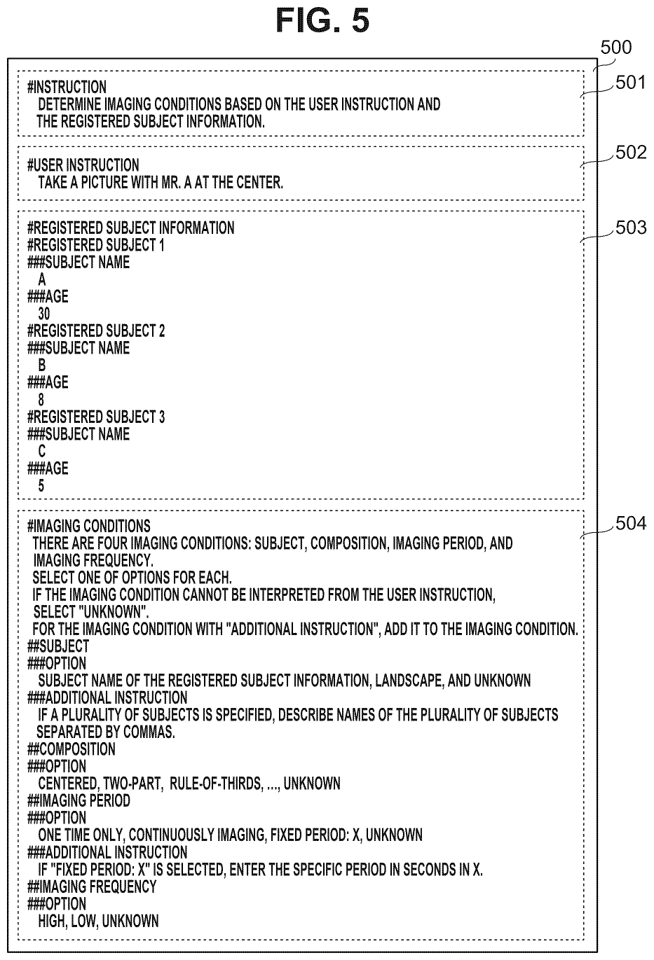

FIG. 5 is a diagram illustrating an example of the prompt 500 that is transmitted from the imaging apparatus 100 to the imaging purpose estimation server 300 according to the present embodiment. The prompt 500 is described by character strings of natural language. The prompt 500 includes an overall instruction section 501, a user instruction description section 502, a registered subject information description section 503, and an imaging purpose generation instruction description section 504.

The overall instruction section 501 is an area where an instruction to the imaging purpose estimation server 300 is described.

In the overall instruction section 501, content of an instruction to generate imaging conditions based on a user instruction and registered subject information is described.

In the user instruction description section 502, the character string data of the user instruction converted by an arbitrary sentence instruction input function is described.

In the registered subject information description section 503, the subject information registered in a storage unit by a subject information registration function is described. The subject information includes, for example, a subject name and age.

In the imaging purpose generation instruction description section 504, an instruction for an item of the imaging conditions to be generated along with a list of possible values that each imaging condition can take are described. An additional instruction may also be described as necessary.

### (Description of Imaging Sequence)

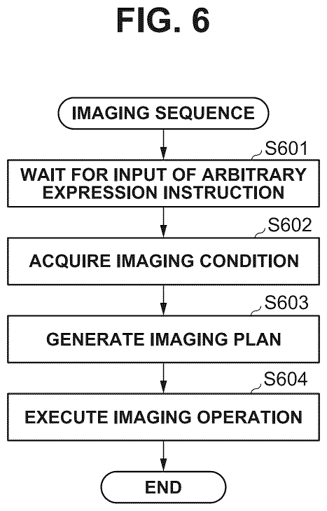

FIG. 6 is a flowchart illustrating a series of processing from reception of an instruction to an imaging operation by the imaging apparatus 100 according to the present embodiment. The series of processing is performed by the control unit 217.

In step S601, the control unit 217 waits for a user to input an arbitrary expression instruction. In response to detection of completion of the instruction input, the processing proceeds to the next step.

In step S602, the imaging apparatus 100 inputs the audio data that is the arbitrary expression instruction input by the user to the audio processing unit 215 and converts the audio data into a character string. The imaging apparatus 100 further generates a prompt to be transmitted to the imaging purpose estimation server 300 by using the converted character string and transmits it to the imaging purpose estimation server 300 via the communication unit 218. Then, the imaging apparatus 100 receives the imaging conditions according to the prompt generated by the imaging purpose estimation server 300.

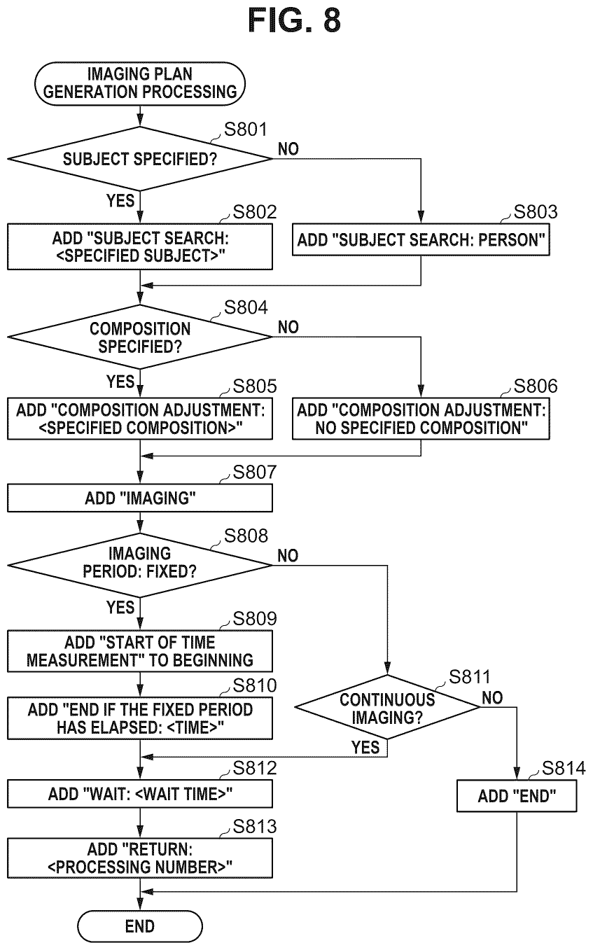

In step S603, the control unit 217 generates an imaging plan based on the imaging conditions received in response in step S602. Generating the imaging plan is described in detail below (FIG. 8).

In step S604, the control unit 217 executes an imaging operation according to the imaging plan generated in step S603.

### (Imaging Plan and Imaging Operation)

Here, the imaging plan and imaging operation according to the present embodiment are described. The imaging plan is a plan for a series of operations that the imaging apparatus 100 performs to capture an image according to the content of the instruction input by the user. The imaging plan is generated by the control unit 217 based on the imaging conditions received from the imaging purpose estimation server 300 in response to the input user instruction, and is stored in the RAM 219 of the imaging apparatus 100. Since the instruction input by the user may not include all the information for use in the imaging operation, the imaging plan is generated by supplementing missing information before the imaging operation is started.

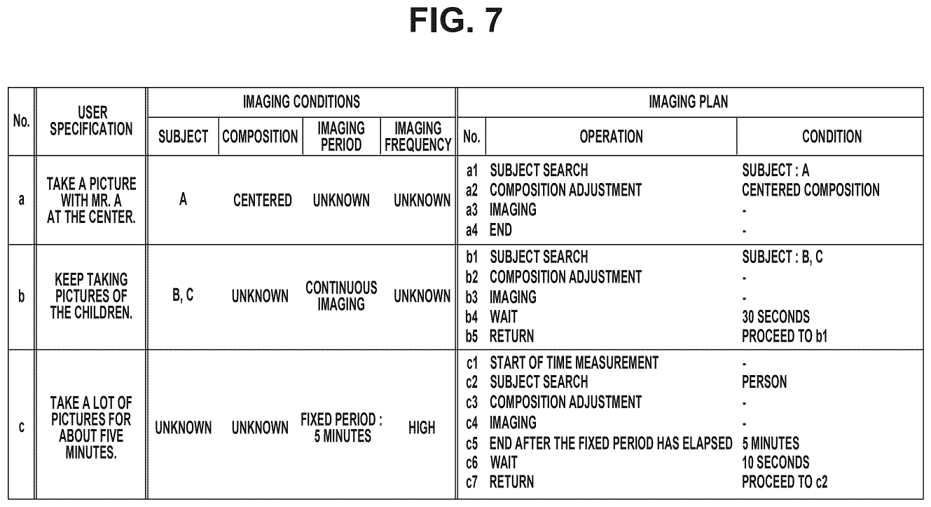

FIG. 7 is a diagram illustrating how the imaging conditions and the imaging plan are output in response to the input user instruction according to the present embodiment. The imaging conditions and the imaging plan that are output in response to three specific user instruction examples a, b, and c are described with reference to FIG. 7.

First, the example a of a user instruction, “Take a picture with Mr. A at the center,” is described. From this sentence, it can be interpreted that the expected subject is A and the user wants to capture an image with A at the center. No other information can be obtained. Thus, in step S602, as a response to an imaging purpose generation request, the imaging purpose estimation server 300 returns that the subject is A, the composition is a centered composition, and the other conditions are unspecified.

In step S603, the imaging apparatus 100 generates the imaging plan based on the imaging purpose to which the response has been received. A specific method for generating the imaging plan from the imaging conditions is described below with reference to FIG. 8.

FIG. 7 is a diagram illustrating an example of an imaging plan in which operations a1 to a4 are generated in response to the example a of the user instruction, “Take a picture with Mr. A at the center.” It can be seen that after the subject A is found by the subject search (a1), a composition is adjusted to a centered composition in which an image is captured with the subject at the center (a2), and then image capturing is performed (a3).

Next, the example b of a user instruction, “Keep taking pictures of the children,” is described focusing on a difference from the example a. From this sentence, it can be interpreted that the expected subject is “children,” and that the user wants to continuously capture images based on the expression, “Keep taking pictures.” No other information can be obtained.

The instruction that the subjects are “children” is a vague expression. In generating the imaging purpose, the imaging purpose estimation server 300 performs determination of whether each subject is an adult or a child, based on the age of the subjects included in the prompt and selects the subjects that fit the request for “children.” In this example, an eight-year-old B and a five-year old C are selected.

In response to the expression, “Keep taking pictures,” which indicates an expectation of continuous imaging, the imaging purpose estimation server 300 selects “continuous imaging” as an imaging period.

Operations b1 to b5 in FIG. 7 are examples of the imaging plan that is generated in response to the example b of the user instruction, “Keep taking pictures of the children.” To realize continuous imaging, the imaging plan is configured in such a manner that after an imaging operation (b3) is performed, the imaging apparatus 100 waits for a certain period of time after imaging and then returns to the subject search (b4 and b5).

Next, the example c of a user instruction, “Take a lot of pictures for about five minutes,” is described focusing on differences from the examples a and b. From this sentence, it can be interpreted that the user wants the imaging apparatus 100 to capture images for a certain period of time and capture many images. No other information about the subject or composition can be obtained. Thus, in step S602, the imaging purpose estimation server 300 replies that the imaging period is five minutes, and the imaging frequency is increased in response to the imaging purpose generation request.

Operations c1 to c7 in FIG. 7 are examples of the imaging plan that is generated in response to the example c of the user instruction, “Take a lot of pictures for about five minutes.” The operations c1 and c5 realize imaging for a certain period of time. By shortening a waiting time after imaging (c6) compared to a usual waiting time, the request for increasing the imaging frequency is accommodated.

A result of imaging purpose generation by the imaging purpose estimation server 300 is an inference result based on the LLM, and thus the result may not be as described above.

### (Description of Imaging Plan Output)

FIG. 8 is a flowchart illustrating a procedure for generating an imaging plan based on imaging conditions.

First, in step S801, the processing is branched based on a determination of whether an imaging target has been specified as “subject” in the imaging conditions.

In a case where the subject has been specified (YES in step S801), the processing proceeds to step S802. In step S802, “subject search: <specified subject>” is added to the imaging plan. In the place of <specified subject>, the subject name specified in the imaging conditions is specified. The subject name functions as an identifier that can uniquely identify the subject based on the registered subject information recorded in the recording medium 214 by the recording unit 213.

In a case where the subject has not been specified (NO in step S801), namely “subject” is “unknown,” the processing proceeds to step S803. In step S803, “subject search: person” is added to the imaging plan. “Person” functions as a specifier that specifies that an arbitrary person is to be searched for.

In step S804, the processing is branched based on a determination of whether a composition has been specified as “composition” in the imaging conditions.

In a case where the composition has been specified (YES in step S804), the processing proceeds to step S805. In step S805, “composition adjustment: <specified composition>” is added to the imaging plan. In the place of <specified composition>, the composition name specified in the imaging conditions is specified.

In a case where the composition has not been specified (NO in step S804), namely “composition” is “unknown,” the processing proceeds to step S806. In step S806, “composition adjustment: no specified composition” is added to the imaging plan. “No specified composition” functions as a specifier that does not specify a specific composition and specifies selection of an appropriate composition in response to a subject detection situation during image capture.

In step S807, “imaging” is added to the imaging plan.

In steps S808 to S814, the processing is branched based on the content specified as “imaging period” in the imaging conditions.

In a case where the imaging period is “fixed period” (YES in step S808), the processing proceeds to step S809. In step S809, “start of time measurement” is added to the beginning of the imaging plan. In step S810, “end if the fixed period has elapsed: <time>” is added to the imaging plan. In the place of <time>, the value of the imaging period specified in the imaging conditions is specified.

In step S812, “wait: <wait time>” is added to the imaging plan. The value of <wait time> that is output for the imaging plan is based on the specification of “imaging frequency” in the imaging conditions. Because the wait time and the number of captured images are in an inverse relationship, if a specific combination of the wait time and the imaging frequency is used as a reference, increasing the imaging frequency beyond the reference can be achieved by shortening the wait time. According to the present embodiment, as the reference combinations, in a case of normal imaging frequency, the wait time is set to 30 seconds, and in a case where the imaging frequency is specified as “high,” the wait time is set to 10 seconds. In a case where “imaging frequency” is “unknown,” the wait time is specified as 30 seconds to perform imaging at the normal imaging frequency.

In step S813, “return: <processing number>” is added to the imaging plan. In the place of <processing number>, an identifier that uniquely identifies the processing to return to is specified. While, normally, the first processing of the imaging plan is specified as <processing number>, in a case where the “start of time measurement” processing is added to the beginning of the imaging plan in step S809, the processing next to the “start of time measurement” processing is specified.

In a case where the imaging period is other than the above-described “fixed period” (NO in step S808), the processing proceeds to step S811. In step S811, in a case where the imaging period is “continuous imaging” (YES in step S811), the processing proceeds to step S812. In step S812, “wait: <wait time>” is added to the imaging plan, and in step S813, “return: <processing number>” is added to the imaging plan.

In a case where the imaging period is other than the above-described “continuous imaging” (or “fixed period”) (NO in step S811, “unknown” is included here), the processing proceeds to step S814, and in step S814, “end” is added to the imaging plan.

As described above, the imaging apparatus 100 can generate the imaging plan based on the imaging conditions.

### (Description of Imaging Operation)

A specific method for performing subject search and composition adjustment in the imaging operation is described.

First, subject search is described. The subject search according to the present embodiment is an operation of detecting a subject while changing an imaging area by pan/tilt/zoom drive of the lens barrel 101 and finding a specific subject. By performing the subject search and finding the specific subject, the imaging apparatus 100 can adjust the composition and capture an image of the subject. Here, a case where “B” is specified as <specified subject> is described.

The imaging apparatus 100 periodically captures images while panning the lens barrel 101 from a left end to a right end of a pan angle at a constant speed, and the subject detection unit 223 detects a person within the imaging area. In a case where a person is detected, determination of whether the detected person matches the subject B in the registered subject information recorded in the recording medium 214 by the recording unit 213 is performed. In case where they match, it is determined that the subject B has been detected, and the subject search is terminated. In a case where they do not match, the subject search resumes from that position. In a case where the subject is not detected even after searching an entire search range, the search is performed again from the left end of the pan angle and repeated until the subject B is detected.

While the method for detecting a subject sequentially from the pan drive end is described as a method for subject search, the present disclosure is not limited to this method. For example, there is a method for detecting a subject sequentially from the center of the pan drive range towards both ends, or the like.

Composition adjustment is now described. The composition adjustment according to the present embodiment is an operation of adjusting positions of the subject and another object within the imaging area using pan, tilt, and zoom functions of the lens barrel 101. In image capturing, generally, various types of imaging compositions have been proposed for the purpose of emphasizing a subject or providing visual stability in a picture. Here, a case where “centered composition” is specified as <specified composition> and a case where “rule-of-thirds” is specified as <specified composition> are described.

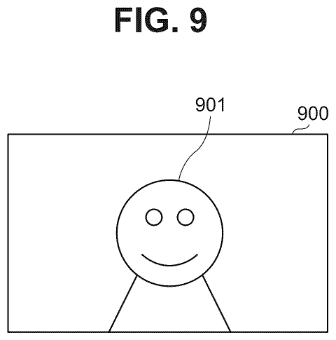

First, a case where “centered composition” is specified as <specified composition> is described with reference to FIG. 9. FIG. 9 is a diagram illustrating an imaging area 900 and a subject 901. The centered composition is a composition in which the subject is captured large and at the center of the image. First, a face center position and a face size in a vertical direction in the imaging area 900 are output from the subject information detected by the subject search. Pan and tilt amounts are output and the lens barrel 101 is driven in such a manner that the face center position matches the image center position. Finally, a zoom amount is output in such a manner that the face size in the vertical direction is set to be half a vertical size of the imaging area 900, and the lens barrel 101 is driven. By the above-described processing, the composition can be adjusted to the centered composition for the arbitrary subject.

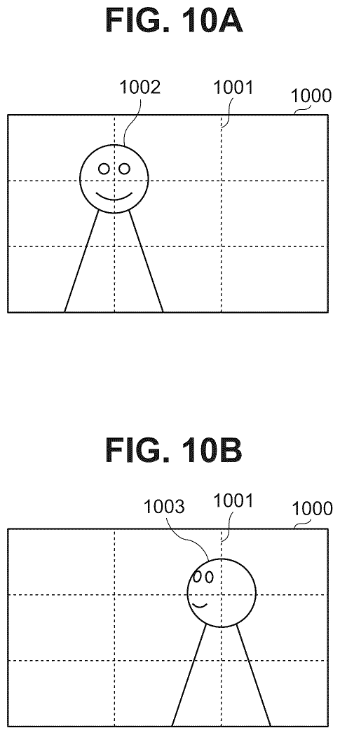

Next, a case where “rule-of-thirds” is specified as <specified composition> is described with reference to FIG. 10A. FIG. 10A illustrates an imaging area 1000 and dashed lines 1001, which are dividing lines described below. A subject 1002 is illustrated. The rule-of-thirds composition is a composition in which the imaging area is divided into three equal parts both vertically and horizontally by dividing lines, and the main subject is positioned either at the intersections of these lines or along the lines themselves. Here, a method for adjusting the rule-of-thirds composition in a case where one person is a subject is described.

First, the face center position and the face size in the vertical direction of the subject in the imaging area are output from the subject information detected by the subject search.

A point where the subject 1002 is to be positioned is selected from the intersection points of the dividing lines. While various methods may be used as a method for selecting the point where the subject is to be positioned, in a case where the subject is a person, it is desirable to select either the upper right or upper left intersection point. A direction of the subject's face may be further acquired from the subject information, and in a case of a profile view, right or left may be selected according to the direction of the face. FIG. 10B illustrates a positioning example of a subject in a case where a subject 1003 faces sideways. In a case where the subject 1003 faces sideways, it is desirable to leave a large white space in the direction to which the face is directed. In other words, in a case where the subject 1003 faces left in the imaging area, the upper right intersection point is selected.

Once the point where the subject is to be positioned is selected, the pan and tilt amounts are output and the lens barrel 101 is driven in such a manner that the face center position of the subject matches the position of the selected point.

Finally, the zoom amount is output in such a manner that the face size in the vertical direction becomes one third of the vertical size of the imaging area, and the lens barrel 101 is driven. By the above-described processing, the composition of the arbitrary subject can be adjusted to the rule-of-thirds composition.

In a case where “no specified composition” (also referred to as “unknown”) is specified as <specified composition>, and when a person is detected, the person is regarded as the subject, and the centered composition is set. In a case where no person is detected, the image is processed as a landscape image capturing, and a zoom amount is set to a wide-angle end (a state where a focal length is the shortest). Various other methods may be used for the composition adjustment in a case of “no specified composition” (or “unknown”). For example, a method for storing a composition in previous imaging and selecting a composition different from the previous one to increase variations or a method for outputting a composition based on information, such as the direction of the detected person's face, the number of people, birthday, and the like, can be used.

### (Summary of First Embodiment)

As described above, according to the configuration of the present embodiment, even in a case where an instruction from a user is vague and expressed in colloquial language, an imaging operation desired by the user can be performed.

While the function of inputting an instruction using arbitrary sentence information is described as the method for audio recognition using the audio input unit 222 and the audio processing unit 215, a different configuration may be used to input an arbitrary sentence instruction. For example, a character string may be directly input using a character input device, such as a keyboard or the like. Alternatively, a configuration may be adopted in which a character string is received via a chat application or the like that runs on another device, such as a smartphone or the like.

The imaging condition may be generated within the imaging apparatus 100.

Although the method of receiving the imaging condition from the imaging purpose estimation server 300 is described as a method of receiving it as a character string in an arbitrary format, the present disclosure is not limited to this method. For example, a method in which an additional instruction is issued to the imaging purpose estimation server 300 to respond in a specific format, such JavaScript Object Notation (JSON) or Extensible Markup Language (XML), or a method in which an instruction is issued to the imaging purpose estimation server 300 to receive the imaging condition as an argument to the function calling provided in a generative pre-trained transformer (GPT) model of OpenAI, Inc., or the like, may also be employed.

The estimation unit 302 may use various methods, such as a machine learning method different from LLM, a method for generating the imaging condition by morphological analysis and conditional branching, and others. In that case, a method for inputting an imaging purpose generation request may be modified in such a manner that an appropriate method is used in accordance with the estimation unit to be used.

The prompt 500 is not limited to the above-described configuration.

For example, a configuration may be adopted in which a person in the vicinity of the imaging apparatus 100 is detected prior to generating the prompt, and the person in the vicinity of the imaging apparatus 100 may be included in the prompt as a subject candidate.

Further, detailed information about the detected person (for example, information about a relative position and an orientation with respect to the imaging apparatus 100, a size of the subject in the imaging area, a facial expression, a pose, belongings, clothing, and the like) may be included.

The prompt may include information other than a character string as long as it is information that can be received by the estimation unit 302. For example, in a case where the estimation unit 302 receives audio information, the prompt may be configured to directly include the audio data about the user instruction. In a case where the estimation unit 302 receives image information and video information, an image or a video captured by the imaging unit 202 may be included in the prompt.

While the method for using “subject,” “composition,” “imaging period,” and “imaging frequency” as the imaging conditions is described, the imaging conditions are not limited to these combinations and can be changed to various combinations. For example, imaging conditions specifying brightness or blur amount may be added.

An imaging condition indicating whether to capture a moving image or a still image may be added.

The configuration may also be such that the imaging purpose estimation server 300 is instructed to generate up to the imaging plan.

Although the method for generating an imaging plan and then operating according to the plan is described, a method for substituting an imaging condition as a parameter of an imaging plan generated in advance may also be used.

An imaging instruction may be further received from a user during the imaging operation.

In this case, the instruction from the user may be a differential instruction from the previous instruction. The differential instruction refers to an instruction to correct the imaging operation that is being performed (or has been performed) based on the user instruction, such as “Take a picture of B instead of A” or “Take a picture a little brighter.”

The prompt 500 may be configured to accommodate such a differential instruction. For example, the response to the differential instruction can be realized in such a manner that the previous instruction and the current instruction may be described together, and an instruction to refer to the previous instruction as needed is described in the user instruction description section 502 of the prompt 500.

Alternatively, in the imaging purpose generation in step S602, an instruction to determine whether the user instruction is the differential instruction is issued to the imaging purpose estimation server 300 prior to issuing an imaging purpose generation instruction. Then, in a case where it is determined that the user instruction is the differential instruction, the prompt 500 may be described to generate imaging conditions factoring in the previous instruction.

Although, in the composition adjustment in the imaging apparatus 100, the positions of the subject and the other object within the imaging area are adjusted by the pan, tilt, and zoom drives of the lens barrel 101, the present disclosure is not limited to this. The composition adjustment can also be achieved by, for example, providing the imaging apparatus 100 with a function of acquiring a wide-angle image, such as an omnidirectional image or a semicircular image, and then trimming the wide-angle image to adjust an angle of view of the image.

### Second Embodiment

According to the first embodiment, the example of processing for executing desired imaging even in a case where an imaging instruction from a user to the imaging apparatus 100 includes colloquial language has been described. According to a second embodiment, in addition to the first embodiment, an example of an imaging apparatus is described that can capture an image that further reflects a user's intention by inquiring with the user about missing information in a case where an imaging instruction received from the user lacks sufficient detail. The configurations of the imaging apparatus 100 and the imaging purpose estimation server 300 are the same as those described in the first embodiment, so that the redundant description is omitted, and a difference from the first embodiment is described.

### (Description of Inquiry About Missing Information)

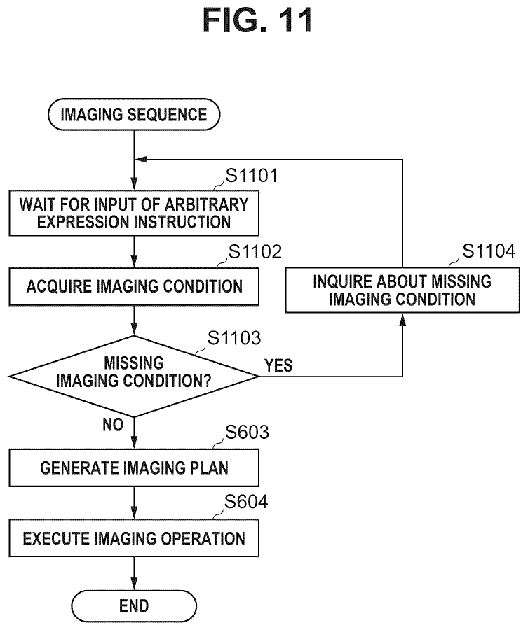

FIG. 11 is a flowchart illustrating a procedure of a series of imaging sequences from receiving an instruction to performing the imaging operation, factoring in a lack of information. This flowchart is a modification of the flowchart described in FIG. 6 according to the first embodiment, factoring in the lack of information. The series of processing is performed by the control unit 217.

First, immediately after the start of the sequence, the control unit 217 receives an imaging instruction from a user in step S1101 and generates imaging conditions in step S1102, which are similar to steps S601 and S602 in the first embodiment.

In step S1103, the control unit 217 determines whether there is missing information for generating the imaging plan in the imaging conditions received in response. A simple determination method is that in a case where there is “unknown” information, it is determined that there is missing information. It is more desirable to change the determination method according to the type of imaging condition. For example, in a case where the subject or the imaging period is “unknown,” it may be determined that there is missing information. On the other hand, in a case where the composition or the imaging frequency is “unknown,” it may be determined that there is no missing information.

In step S1103, in a case where it is determined that there is no missing information (NO in step S1103), the processing proceeds to step S603, and the imaging plan is generated. Step S603 and subsequent step S604 are the same as those according to the first embodiment.

In step S1103, in a case where it is determined that there is missing information (YES in step S1103), the processing proceeds to step S1104. In step S1104, inquiry about the missing imaging condition is performed. In step S1104, audio data corresponding to the imaging condition determined in step S1103 to be missing is output from a speaker of the notification unit 216 to notify the user of the fact. For example, in a case where “subject” information is missing, the audio data may be a voice, such as “Who do you want to take a picture of?” The audio data corresponding to each imaging condition is prepared in advance. Alternatively, the audio data may be dynamically generated according to the missing information.

After inquiring about the missing imaging condition in step S1104, the processing returns to step S1101 to wait for a response from the user. In this processing, that the missing imaging condition is being inquired about is also stored.

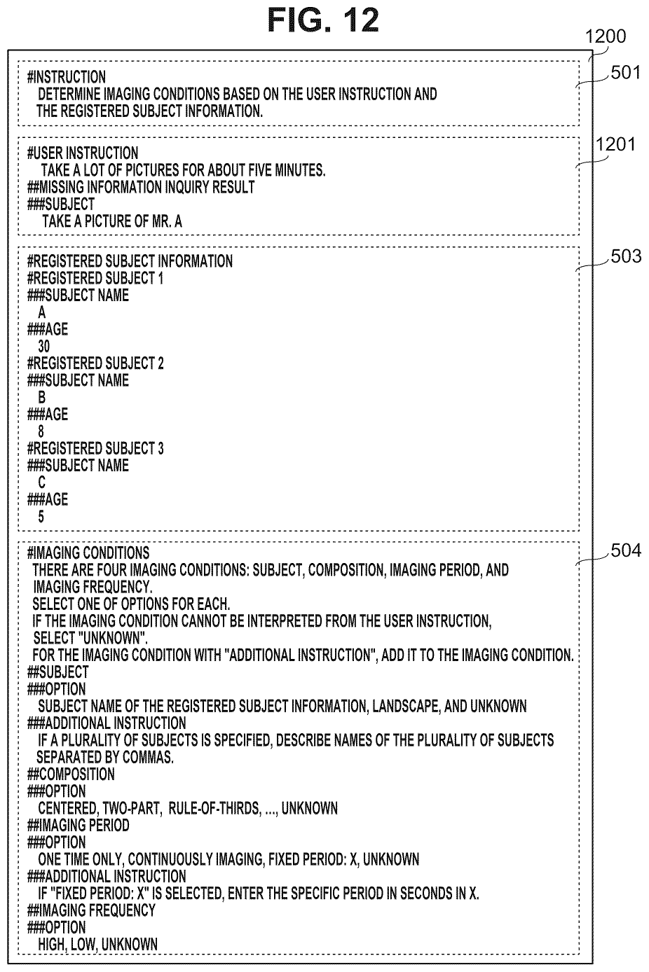

In step S1101, input from the user is received again, and in step S1102, an imaging purpose is generated again. In a case where the missing imaging condition is being inquired about, additional information is added to a prompt 1200 to be transmitted to the imaging purpose estimation server 300. FIG. 12 is a diagram illustrating an example of the prompt 1200.

For example, in a case where the user inputs, “Take a picture of Mr. A,” as a result of inquiring about “subject” as the missing information, the result of the inquiry about the subject is described as in a section 1201.

### (Summary of Second Embodiment)

As described above, according to the configuration of the present embodiment, even in a case where the content of an imaging instruction received from a user lacks sufficient details, imaging can be performed that further reflects a user's intention.

The method for inquiring about the missing imaging condition before generating the imaging plan is described, but timing of the inquiry is not limited to this. For example, in a case where the imaging period is “unknown,” a method in which the imaging plan is generated and an imaging operation is performed by tentatively setting the imaging period to “one time only,” and then, a confirmation such as, “Imaging has been completed. Do you wish to continue imaging?” is presented may be employed.

Confirmation content may be changed according to information about a subject being detected and a past imaging situation. For example, in a case where “subject” is “unknown” and many people are detected in the vicinity of the imaging apparatus 100, an inquiry such as “Do you want to take pictures of everyone evenly?” may be presented. In a case where “subject” is “unknown” and a person C who was specified as “subject” many times in the past is detected, an inquiry such as “Do you want to take a picture of Mr. C?” may be presented.

### Third Embodiment

According to a third embodiment, in addition to the first embodiment, in a case where a received user instruction is similar to one in a response history, an imaging operation is performed based on the response history without communicating with an imaging purpose estimation server. The configuration of the imaging apparatus 100 is the same as that described in the first embodiment, so that the redundant description is omitted, and a difference from the first embodiment is described.

### (Configuration of Imaging Purpose Estimation Server)

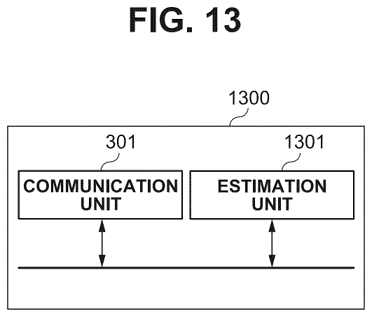

FIG. 13 is a diagram illustrating a configuration of an imaging purpose estimation server 1300 according to the present embodiment. The imaging purpose estimation server 1300 includes the communication unit 301 and an estimation unit 1301.

The estimation unit 1301 estimates a keyword that contributes to determination of the imaging conditions (“subject,” “composition,” “imaging period,” and “imaging frequency”) based on a prompt 1500 described below in addition to the estimation unit 302 according to the first embodiment.

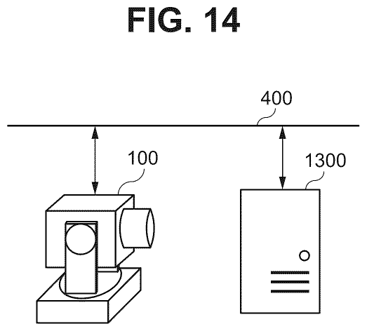

The imaging apparatus 100 and the imaging purpose estimation server 1300 exchange information via a network 400 using the respective communication units (FIG. 14).

### (Description of Prompt)

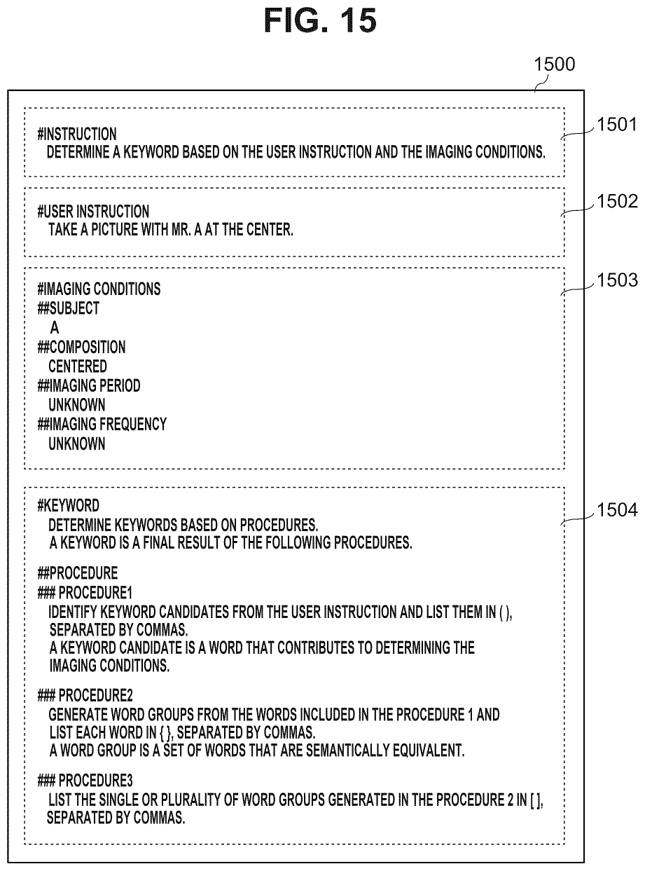

FIG. 15 is a diagram illustrating an example of the prompt 1500 that is transmitted from the imaging apparatus 100 to the imaging purpose estimation server 1300 according to the present embodiment. The prompt 1500 is described by character strings of natural language. The prompt 1500 includes an overall instruction section 1501, a user instruction description section 1502, an imaging purpose description section 1503, and a keyword output instruction description section 1504.

The overall instruction section 1501 is an area where an instruction to the imaging purpose estimation server 1300 is described. In the overall instruction section 1501, content of an instruction to output a keyword based on the user instruction and the imaging conditions is described.

The user instruction description section 1502 is an area where character string data of the user instruction converted by an arbitrary sentence instruction input function is described.

The imaging purpose description section 1503 is an area where the imaging conditions are described.

The keyword output instruction description section 1504 is an area where a definition and an instruction on an output format of a keyword to be output are described.

### (Description of Imaging Sequence)

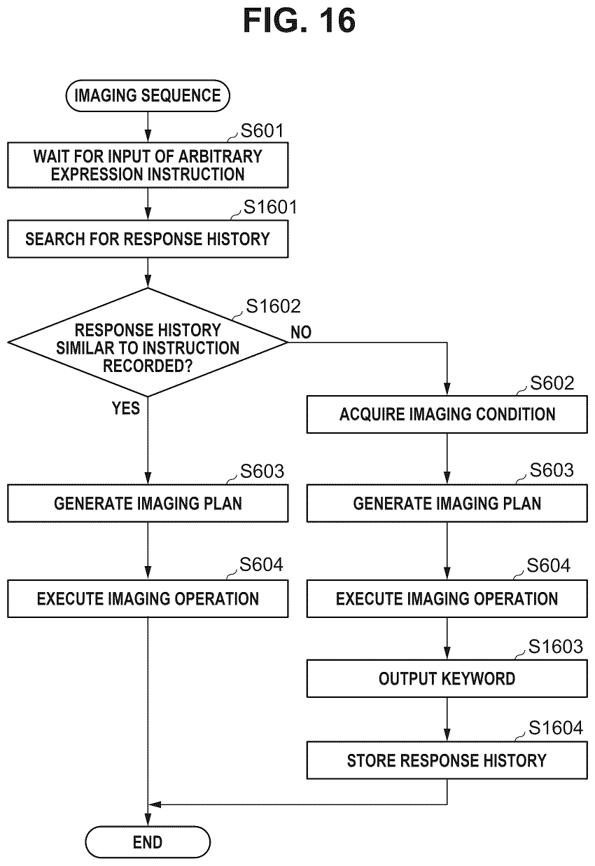

FIG. 16 is a flowchart illustrating a procedure of a series of imaging sequences from receiving an instruction to performing an imaging operation by the imaging apparatus 100 according to the present embodiment. In this flowchart, searching for a response history and changing a record are added to the flowchart illustrated in FIG. 6 according to the first embodiment. The series of processing is performed by the control unit 217.

In step S1601, the control unit 217 searches for whether a response history similar to an arbitrary expression instruction input by the user in step S601 is stored.

In step S1602, the control unit 217 determines whether a response history similar to the arbitrary expression instruction input by the user has been recorded, as a result of the search in step S1601. In a case where the response history is recorded (YES in step S1602), the processing proceeds to step S603, whereas if not (NO in step S1602), the processing proceeds to step S602.

In step S1603, the control unit 217 outputs a keyword that has contributed to the determination of the imaging conditions based on the arbitrary expression instruction input in step S601 and the imaging conditions received in step S602. More specifically, the following operations are performed. The control unit 217 generates the prompt 1500 to be transmitted to the imaging purpose estimation server 1300 using the arbitrary expression instruction and the imaging conditions, and transmits the prompt 1500 to the imaging purpose estimation server 1300 via the communication unit 218. The imaging purpose estimation server 1300 outputs a keyword according to the prompt 1500 and transmits the keyword to the imaging apparatus 100. The imaging apparatus 100 receives the keyword.

In step S1604, the control unit 217 records the response history based on the imaging conditions received in step S602 and the keyword output in step S1603.

### (Description of Keyword)

Here, the keyword according to the present embodiment is described. The keyword is a set of words contained in the user instruction that has contributed to a determination of the imaging conditions and words that are semantically equivalent.

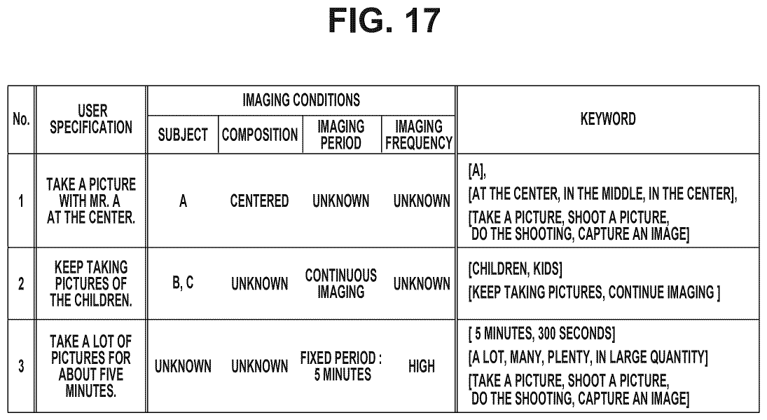

FIG. 17 is a diagram illustrating a keyword output generated in response to the input user instruction. An item No. 1 is described as an example. The imaging conditions output from a sentence of a user instruction, “Take a picture with Mr. A at the center,” are that the “subject” is A, the “composition” is “centered composition,” and the “imaging period” and the “imaging frequency” are “unknown.” From this, it can be estimated that the words contained in the user instruction and that contribute to the determination of the imaging conditions are “A,” “at the center,” and “take a picture.” Next, a word semantically equivalent is estimated for each word. As for “A,” it is a proper noun and there is no other word that is semantically equivalent, and thus no word other than “A” is estimated. On the other hand, as for “at the center,” it indicates the user's intention to position the subject in the center of the angle of view, so that it can be estimated that “in the middle,” “in the center,” and the like are also semantically equivalent words. Similarly, as for “take a picture,” “shoot a picture,” “do the shooting,” and the like can be estimated as semantically equivalent. Thus, as a response to a keyword output request, the imaging purpose estimation server 1300 returns “{A}, {at the center, in the middle, in the center}, {take a picture, shoot a picture, do the shooting, capture an image}”.

### (Description of Recording of Response History)

Here, a record of the response history according to the present embodiment is described. The response history is data in which the information contained in the imaging conditions and the keyword received in response by the imaging purpose estimation server 1300 are replaced with item names (face picture, name, and birth date) of the information stored in the subject information recorded in the recording medium 214 by the recording unit 213.

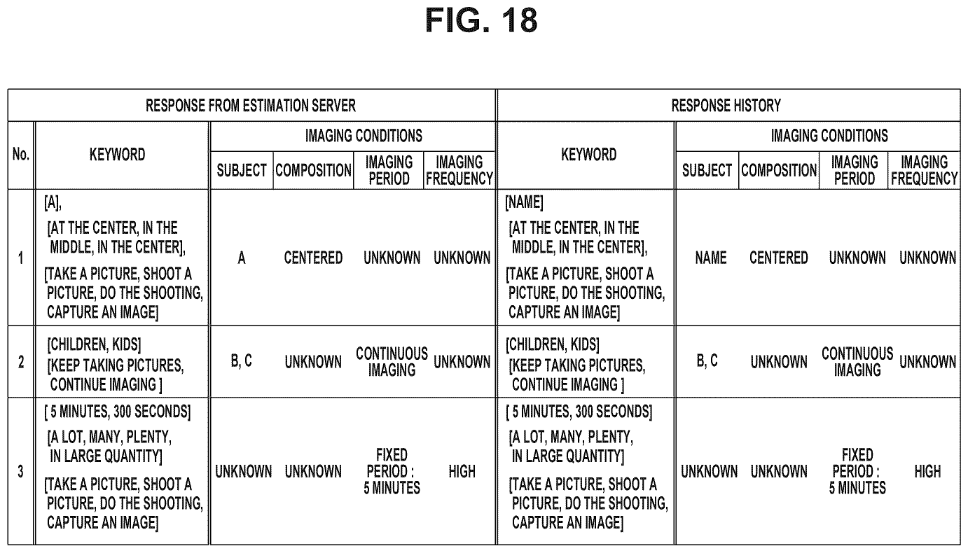

FIG. 18 is a diagram illustrating an output response history with respect to the output imaging conditions and keyword. An item No. 1 is described as an example. The imaging conditions and keywords received in response from the imaging purpose estimation server 1300 include “A” recorded in the subject information. Determination of whether the imaging conditions and keywords include the subject information can be performed by exhaustively comparing character strings of the imaging conditions and keywords with the subject information recorded in the recording medium 214 by the recording unit 213. Since “A” is information stored in the item “name” of the subject information, “A” in the imaging conditions and keywords is replaced with “name.”

As described above, the response history is recorded by adding to the response history the data in which the imaging conditions and keywords received in the response have been replaced.

### (Description of Search for Response History Similar to User Instruction)

Here, a search for a response history similar to a received user instruction is described. A response history similar to the user instruction is searched for by determining similarity between the keyword restored from the response history based on the subject information and the received user instruction. First, a method for outputting the keyword restored from the response history is described, and then, a method for determining the similarity between the user instruction and the restored keyword is described.

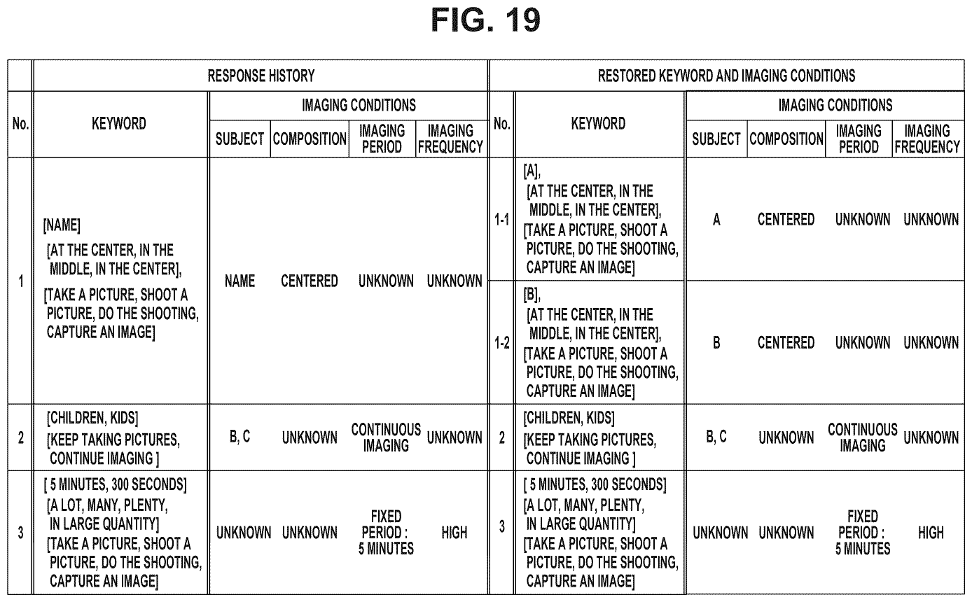

FIG. 19 is a diagram illustrating an output keyword restored from the response history. For the sake of explanation, a case is described in which two pieces of subject information with names “A” and “B” are recorded. The item names of the subject information included in the keyword in the response history are replaced with all the recorded subject information. In this case, data in which “name” is replaced with “A” and then “B” is generated. By performing these procedures in order from item No. 1 of the response history, the restored keywords as illustrated in FIG. 19 are output. The same procedure is also performed on the remaining imaging conditions, and the remaining imaging conditions restored from the response history are output.

Subsequently, determination is performed as to whether the user instruction and the restored keywords are similar to each other by comparing them. For example, in a case where, for each group enclosed in braces { } in the restored keywords, any of the character strings in the braces { } is included in the user instruction, it may be determined that the user instruction and the restored keyword are similar. An example in which “Shoot a picture of B in the middle” is input as the user instruction and the response history as illustrated in FIG. 19 is stored is described.

In restored keyword No. 1-1, three groups, each enclosed in braces { }:{A}, {at the center, in the middle, in the center}, and {take a picture, shoot a picture, do the shooting, capture an image} are included. A comparison between the user instruction and the restored keyword No. 1-1 shows that “in the middle” is included in the user instruction among {at the center, in the middle, in the center} . Among {take a picture, shoot a picture, do the shooting, capture an image}, “shoot a picture” is included in the user instruction. However, {A} is not included in the user instruction. Thus, the restored keyword No. 1-1 and the user instruction are determined to be dissimilar.

Similarly, a restored keyword No. 1-2 is processed. The difference between the restored keywords No. 1-1 and No. 1-2 is that {A} is replaced with {B}. A comparison between the user instruction and the restored keyword No. 1-2 shows that for each group enclosed in the braces { }, any of character strings within the corresponding braces { } is included in the user instruction. Thus, the restored keyword No. 1-2 and the user instruction are determined to be similar.

As described above, a response history similar to the user instruction is searched. In a case where a response history similar to the user instruction is present as a result of the search, an imaging plan is generated based on the imaging conditions that include a combination of the restored keywords.

### (Summary of Third Embodiment)

As described above, according to the configuration of the present embodiment, in a case where a user instruction similar to a response history recorded in the imaging apparatus is received, an imaging operation can be performed based on the response history without communicating with the imaging purpose estimation server.

According to the above-described embodiments, an imaging apparatus that can control an imaging operation based on an instruction of arbitrary expression in automatic imaging based on an imaging instruction from a user can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-193301, filed Nov. 1, 2024, the entirety of which is incorporated herein by reference.

1. An imaging apparatus comprising:
one or more processors that execute a program stored in a memory and thereby function as:
an input unit configured to receive an input of arbitrary sentence information as an imaging instruction;
a transmission unit configured to transmit the arbitrary sentence information received by the input unit to a generation unit for generating an imaging condition based on an arbitrary sentence;
a reception unit configured to receive the imaging condition from the generation unit;
an output unit configured to output an imaging plan based on the imaging condition received by the reception unit; and
a control unit configured to control an imaging unit to perform imaging based on the imaging plan.

2. The imaging apparatus according to claim 1,
wherein the generation unit is a large language model,
wherein the one or more processors that execute the program stored in the memory function further as a prompt generation unit configured to generate a prompt for causing the generation unit to generate an imaging condition, and
wherein the prompt generation unit generates a prompt that specifies using the arbitrary sentence information as an input and generating the imaging condition.

3. The imaging apparatus according to claim 2, wherein the prompt generation unit is a large language model for generating a prompt that specifies using the arbitrary sentence information and the imaging condition as inputs and generating a keyword based on the imaging instruction.

4. The imaging apparatus according to claim 1, wherein at least one of an imaging target subject, a composition, an imaging period, or an imaging frequency is generated as the imaging condition.

5. The imaging apparatus according to claim 1,
wherein the one or more processors that execute the program stored in the memory function further as a registration unit configured to register subject information,
wherein the transmission unit transmits the subject information registered by the registration unit together with the arbitrary sentence information received by the input unit to the generation unit, and
wherein the generation unit generates the imaging condition based on the arbitrary sentence information and the subject information.

6. The imaging apparatus according to claim 5, wherein the one or more processors that execute the program stored in the memory function further as a history recording unit configured to record information that has been acquired by converting a keyword based on the imaging instruction and the imaging condition based on the registered subject information as a response history.

7. The imaging apparatus according to claim 1,
wherein the one or more processors that execute the program stored in the memory function further as a change unit configured to change a composition of imaging,
wherein the control unit controls the imaging unit to perform imaging based on the imaging plan while causing the change unit to change the composition.

8. The imaging apparatus according to claim 7, wherein the change unit changes the composition by using pan and tilt functions of the imaging apparatus.

9. The imaging apparatus according to claim 7, wherein the change unit changes the composition by cropping an image.

10. The imaging apparatus according to claim 7, wherein the change unit changes the composition by using a zoom function of the imaging apparatus.

11. The imaging apparatus according to claim 1, wherein the imaging apparatus detects that information for use in outputting the imaging plan is missing and notifies a user of the missing information.

12. The imaging apparatus according to claim 11, wherein the imaging apparatus causes a display unit to display an inquiry sentence corresponding to the missing information to notify the user of the missing information.

13. The imaging apparatus according to claim 1,
wherein the one or more processors that execute the program stored in the memory function further as a search unit configured to search whether there is a response history similar to the imaging instruction based on the arbitrary sentence information, and
wherein, in a case where there is the similar response history, the output unit outputs an imaging plan based on the response history.

14. The imaging apparatus according to claim 13, wherein the search unit converts the response history based on registered subject information, compares the arbitrary sentence information with the converted response history, and performs a search to determine whether there is a similar response history.

15. The imaging apparatus according to claim 13, wherein the response history includes the imaging instruction based on the arbitrary sentence information, a keyword based on the imaging instruction generated based on the imaging condition, and the imaging condition.

16. A control method for an imaging apparatus having an input unit, the method comprising:
receiving, by the input unit, an input of arbitrary sentence information as an imaging instruction;
transmitting the arbitrary sentence information received by the input unit to a generation unit for generating an imaging condition based on an arbitrary sentence;
receiving the imaging condition from the generation unit;
outputting an imaging plan based on the imaging condition received from the generation unit; and
controlling an imaging unit to perform imaging based on the imaging plan.

17. A non-transitory computer-readable storage medium storing a program for causing a computer to execute the control method according to claim 16.
